(19) United States
(12) Patent Application Publication
(10) Pub. No.: US 2008/0115738 A1
(43) Pub. Date: May 22, 2008

(54) Coats For Animals

(76) Inventor: Toni Jane Cherrett, Alderney (GB)

Correspondence Address: BARNES & THORNBURG LLP, P.O. BOX 2786, CHICAGO, IL, 60690-2786, US

(21) Appl. No.: 10/561,667

(22) PCT Filed: Jun. 25, 2004
(86) PCT No.: PCT/EP04/51245

§ 371 Date: Dec. 20, 2005

(51) Int. Cl. A01K 13/00

(52) U.S. Cl. 119/850

(57) ABSTRACT

An animal coat (6) has two side portions that hang down from the animal's back along sides of the animal's body and define a neck opening (1) that engages around the animal's neck. Two leg holders (4) are each secured to an inner face of the coat (6) at the rear part of a respective one of the side portions, and receive a respective hind leg of the animal. The leg holders (4) are preferably continuous, of stretch material and of appreciable depth—e.g. 10% or more of their maximum circumference. Thus, they provide a secure means of tethering the coat, without tending to cause pressure sores on the animal's legs.

This invention relates to coats for animals, and is concerned, particularly although not exclusively, with coats for domestic pet animals—such as dogs, for example.

Coats for animals have been used for many years. Typically, large animal coats, for example, for horses and cattle, and smaller animal coats, for example, for dogs, have required a coat tethering means such as, for example, either a strap circumambient on the animal's girth region or two straps laying laterally in a crossing over manner on part of the animal's abdomen. Straps passing around the animal's hind limbs have been attached to the animal coat in various ways, and used in conjunction with the straps around the animal's girth region, or by themselves, to tether the animal coat.

The known coat tethering means of a strap, circumambient on the animal's girth region, broad or narrow in size, made of leather, fabric, man-made or natural materials, either padded or non-padded, is attached to the animal coat or left un-attached, and relies upon the pressure brought to bear on the animal coat by the straps when fastened to tether the coat to the animal's back. This has the disadvantage of causing pressure rubs or sores to the animal in the region of direct pressure from the straps and other areas on the animal's body from the everyday movement of the animal whilst wearing the coat.

In inclement weather, such known animal coat tethering means do not prevent gusts of wind blowing the loose part of the animal coat up to the point of the tether on the animal's back. This defeats the object of keeping the animal warm by wearing the coat, and also causes the risk of injury to the animal through fright.

Such means of tethering an animal coat does not prevent the coat from slipping to one side, causing more discomfort and distress to the animal.

Another known coat tethering means (Ayres U.S. Pat. No. 584,661 1897) uses two angled straps fixed to the animal coat at back and shoulder regions at different points, in such a manner that the two straps cross over each other at a point on the animal's belly and are secured at points along the animal's side, such that the effective lengths of the straps are adjustable.

This method of tethering an animal coat has the disadvantage of the animal coat still slipping to one side or the other, especially if the straps have been incorrectly adjusted. If the straps are adjusted too tightly, the animal may risk pressure sores or rubs when in a recumbent position.

Again, in inclement weather, the animal coat risks being disarranged by gusts of wind, although less so when worn by small animals wearing the coat, for example, small dog breeds of the size of miniature poodles, West Highland terriers etc, where the coat relies on the integrity of the material used to make up the animal coat to keep it in place under these conditions.

The use of leg straps passing around the animal's hind limbs and attaching to the animal coat is well documented. This method of tethering an animal coat has been usually used in conjunction with the above coat tethering means to assist stabilising the animal coat. The disadvantage of the use of legs straps is the risk of injury to the sensitive parts of the inner leg should the leg straps be incorrectly fitted or become unattached. Also there is always the risk of an animal becoming entangled with an object, especially in the case of dogs, where their instinct is to hunt in the undergrowth.

The use of leg straps on their own to tether an animal coat eliminates the risk of pressure sores and rubs from using tethering means around the abdomen of the animal, but has all the disadvantages mentioned above, plus the possibility of causing injury to the soft parts of the top of the animal's hind leg should the animal coat slip to one side and not be righted by the animal shaking itself.

Dog garments of complete suits with four legs are used for drying off bathed or wet dogs (Harrell U.S. Pat. No. 6,058,890 1998). Dog “jogging” suits are also complete suits with four legs used mainly for the smaller breeds of dog during light exercise. Overheating may be a problem if anything more than light exercise is performed. A large working dog, for example, a guard dog, would not be taken seriously by an intruder if wearing an animal coat of this nature.

Preferred embodiments of the present invention aim to provide an animal coat that is tethered by a leg tethering means that is comfortable, non-restrictive for the animal and easy to apply to the animal with none of the disadvantages mentioned above.

According to one aspect of the invention, there is provided an animal coat comprising:

two side portions arranged to hang down from the animal's back alongside respective sides of the animal's body;

a neck opening defined by said side portions, and arranged to engage around the animal's neck; and

two leg holders, each secured to an inner face of the coat at the rear part of a respective one of the side portions, and arranged to receive a respective hind leg of the animal.

Preferably, the leg holders are above the lower level of said side portions.

Preferably, each of the leg holders is continuous. In this context, “continuous” means an endless loop or tube of material, in contrast to an item with a releasable or adjustable fastener. The endless loop of material may be made as a single, seamless piece or from one or more pieces of material that are permanently joined as by stitching or other joining method.

Preferably, each of the leg holders is of stretch material.

Preferably, each of the leg holders has a depth that is 10% or more of the maximum circumference of the leg holder. The depth may be at least 8, 10 or 12% of the maximum circumference of the leg holder.

Preferably, each of the leg holders has a depth that is 30% or less of the maximum circumference of the leg holder. The depth may be at most 30, 25 or 20% of the maximum circumference of the leg holder.

A preferred depth of leg holder is in the range 12 to 18% of the maximum circumference of the leg holder.

A preferred depth of leg holder is 15% of the maximum circumference of the leg holder.

Preferably, there is further provided closure means for joining said two side portions such that the coat may be opened and closed to facilitate fitting of the coat

According to another aspect of the invention, there is provided an animal coat comprising:

two side portions arranged to hang down from the animal's back alongside respective sides of the animal's body; and

means for retaining at least one of said side portions in a raised position and releasing that side portion to a lowered position.

Such an animal coat may also be in accordance with any of the preceding aspects of the invention.

Preferably, said retaining means comprises a plurality of tapes secured to the coat and means for securing said tapes in a position in which said at least one side portion is in a raised position.

Preferably, said retaining means is arranged to retain both of said side portions in raised positions and to release said side portions to lowered positions.

Animal coats as above may incorporate any of the features mentioned in this specification.

The invention extends to a method of fitting an animal coat in accordance with any of the preceding aspects of the invention, the method comprising the steps of measuring dimensions of an animal, transferring those dimensions to a pattern, making an animal coat from that pattern, and fitting the coat to an animal.

For a better understanding of the invention, and to show how embodiments of the same may be carried into effect, reference will now be made, by way of example, to the accompanying diagrammatic drawings, in which:

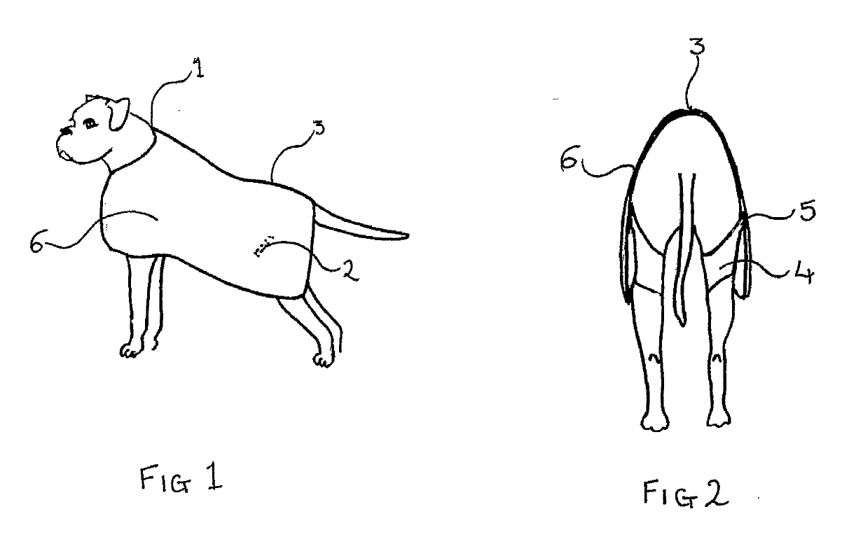

FIG. 1 is a lateral view of a dog wearing an animal coat;

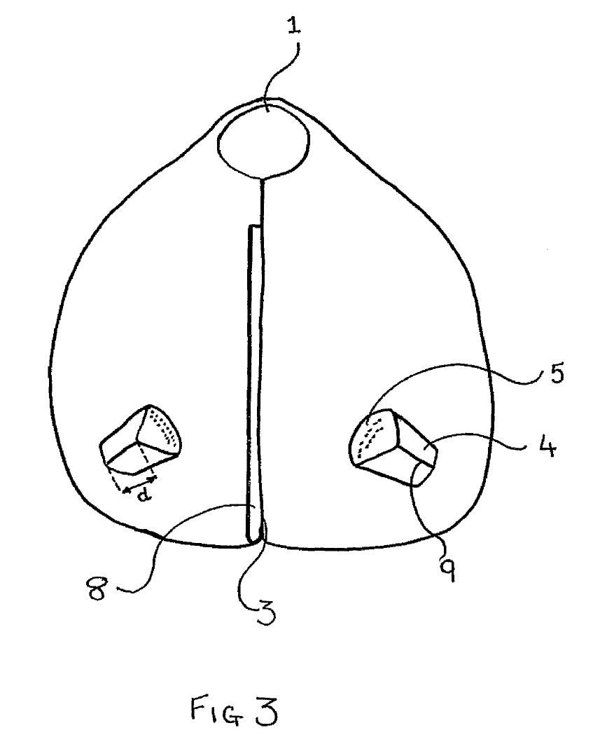

FIG. 2 is a posterior view of the dog wearing the animal coat;

FIG. 3 illustrates the animal coat as viewed from beneath with a closure means closed;

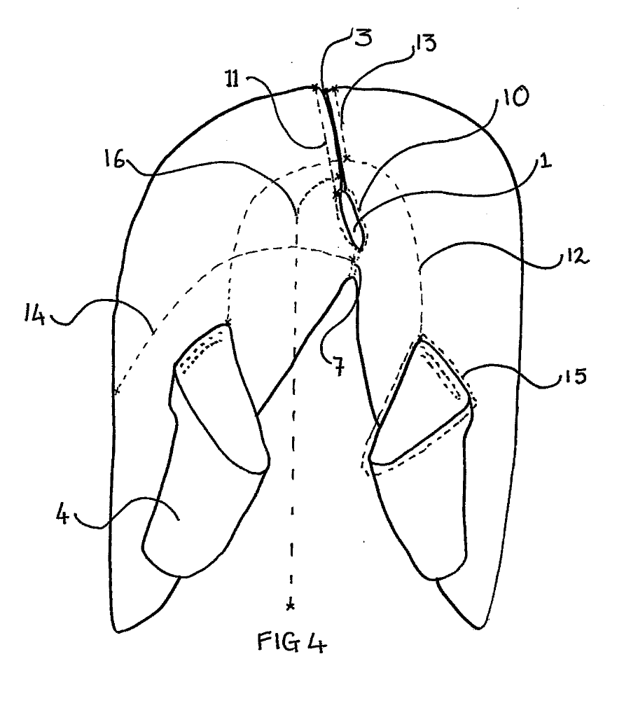

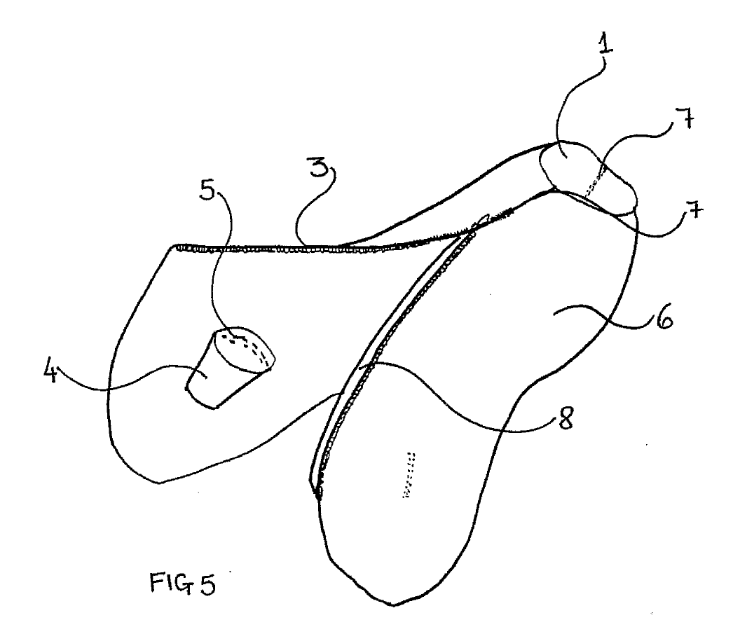

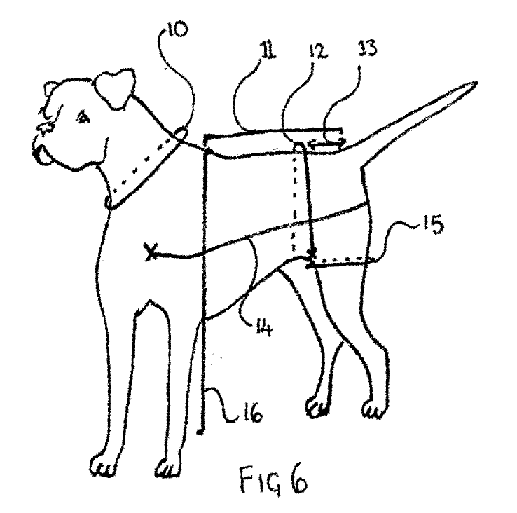

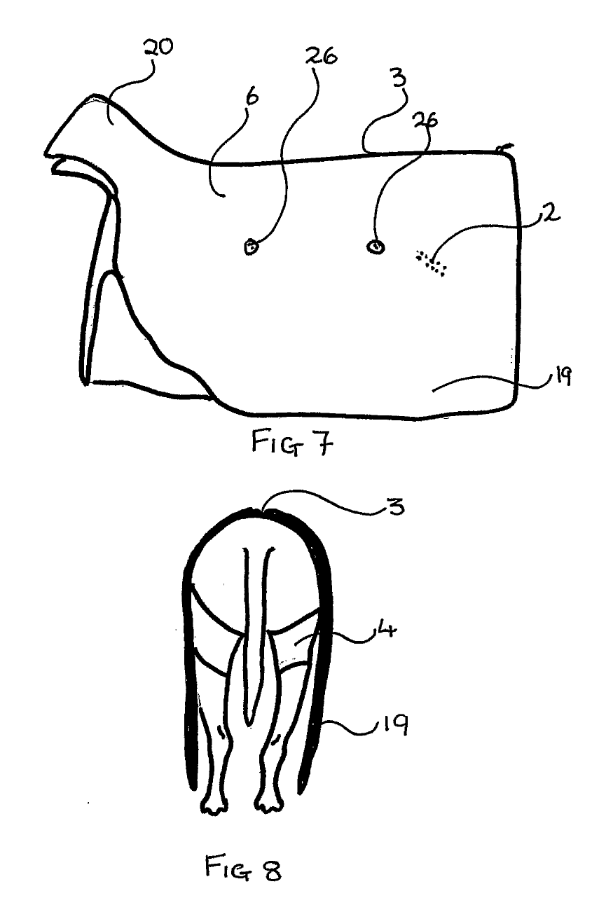

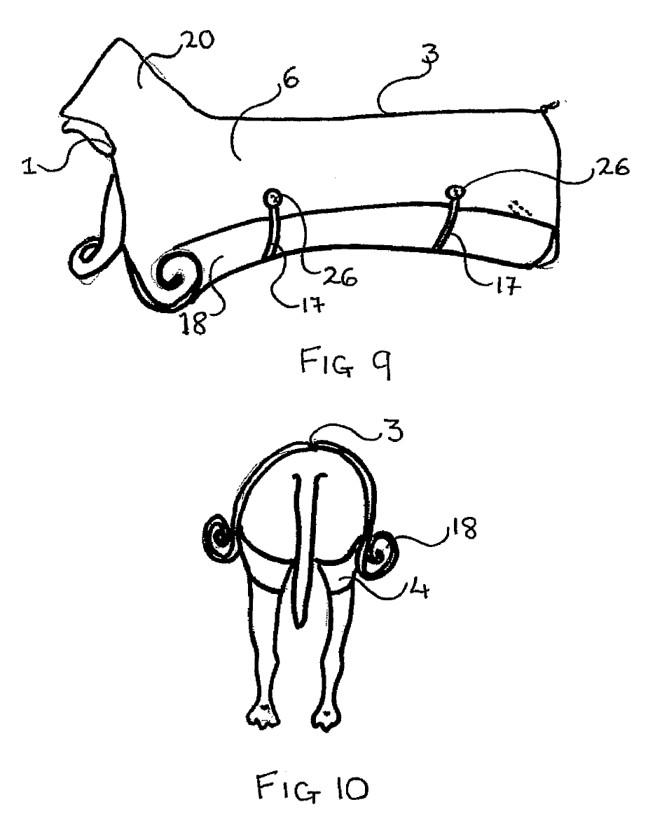

FIG. 4 is a posterior view of the animal coat when not being worn by an animal;

FIG. 5 is a dorsal view of the animal coat with the closure means open; and

FIG. 6 is a perspective view of a dog and coat, showing measurement points;

FIG. 7 illustrates a modified coat;

FIG. 8 is a rear view of the coat of the modified coat, when worn by a dog;

FIG. 9 is a view similar to FIG. 7, but showing sides of the modified coat rolled up; and

FIG. 10 is a view similar to FIG. 8, but showing sides of the modified coat rolled up.

In the figures, like references denote like or corresponding parts.

FIGS. 1 and 2 show an animal coat 6 in situ on a dog. The animal coat 6 comprises two side portions arranged to hang down from the animal's back alongside respective sides of the animal's body. The coat 6 may comprise any suitable fabric—for example, natural or man-made fibres, stretch or non-stretch, water repellent or fire-proofed, lined or unlined. An opening 1 is provided for the animal's head to pass through, and closure means 3 is provided for opening and closing the coat 6 and may comprise, for example, a zip, interengaging hook-and-eye tape (such as Velcro®) or any other suitable closure means. Rear leg holders 4 for tethering the animal coat 6 are affixed to the interior of the animal coat 6 by stitching at points 5, which stitching 2 is visible in FIG. 1.

The animal coat 6 is applied to the animal by opening the closure means 3 as seen in FIG. 5, which is either situated along the dorsal part of the animal coat 6 or on one or both lateral sides of the anal coat 6, above the stitching line 2 of the leg holder 4.

The animal's head is passed through the opening 1, which is defined by the pieces of fabric making up the two side portions, as shown in FIG. 5, joined by stitching 7. The hind limbs of the animal are then passed into and through the leg holders 4, each limb to the corresponding leg holder as shown in FIG. 2. The closure means 3 is then closed. A closure means guard 8 as seen in FIG. 5 prevents the animal's fur or hair being caught in the closure means. This completes the positioning of the animal coat onto the animal.

The above animal coat as described is maintained securely on the animal by a three-point location system and does not rely upon a strap or the like passing around the animal. The three location points comprise (i) the animal's head and neck passing through the opening 1 and (ii, iii) both hind legs being placed through the respective leg holders 4. This affords opposing restraining forces to maintain the animal coat securely in place even when the animal moves.

Each leg holder 4 is made of a soft stretch fabric—for example, Lycra® or Spandex® mixture or any other suitable fabric, which fits closely to the animal's limb contours without becoming too tight. FIG. 3 shows the joining seam stitching 9 which, when the coat is worn by the animal, will be on the inside of the hind limb. The seam stitching 9 could be on the opposite side, or at any other location. Thus, a short tapering sleeve or tube is made for the hind limb to pass into and through to secure the coat on the animal. Tapering of the sleeve or tube is preferred but not essential. The leg holder 4 is affixed to the inside of the animal coat 6 by stitching 2 that is positioned adjacent the top edge of the leg holder 4 such that, when worn, the leg holder 4 is comfortably as far up the animal's hind limb as possible.

The depth of the leg holder 4 is only of a sufficient size to maintain the coat tethered with minimal sight of the leg holder when the animal coat is viewed laterally, and does not cover large areas of the animal's hind limb. How much of the leg holder is viewable depends largely upon the conformation and size of the animal. The narrower the band of material used for a leg holder, the more pressure is brought to bear on the area of the leg—this is one of the main disadvantages of using narrow straps as leg tethering means. The minimum depth d of leg holder 4, as measured along seam 9, is proportional to the size of the animal limb. For example, d=3 to 4 cm for a small dog, 8 to 10 cm for a quite large dog. Elephant bigger still.

FIG. 6 illustrates a method of measuring an animal for the animal coat to fit correctly. The animal's neck circumference 10 is taken at the widest part of the neck, and the length of the back 11 is taken from the base of the animal neck along the full length of the spine to the root of the tail. Measurement 12 is taken from the top of the front of the hind limb, up and over the animal's back and down to the corresponding point on the other side. Measurement 13 is taken from where line 12 passes over the spine to the root of the tail. Measurement 14 is taken from the centre point of the animal's chest and is continued to the point of desired length of coat. Measurement 15 is the circumference of the widest part of the top part of the animal hind limb. Measurements 12,13 and 15 are necessary for the correct placing of the leg holders 4 onto the inside of the animal coat. For a modified coat such as a bath robe as seen in FIG. 7, an extra measurement 16 is taken from point of the measurement 11 by the neck, vertically (known as the ‘drop’) to the base of the lower limb joint (fetlock).

The way in which these measurements relate to the coat is illustrated in FIG. 4.

For optimum fit of the animal coat, it is necessary to provide the animal coat manufacturer with each individual animal's measurements. It is possible to have standard sizes for various breeds. However, as with buying a suit “off the peg” unless the wearer is absolutely standard size, the fit will not be perfect.

The depth of leg holder 4 may advantageously be in the range 12 to 18% of the maximum circumference (15) of the leg holder. A preferred depth of leg holder 4 is about 15% of the maximum circumference (15) of the leg holder, although it could be more or less.

Preferably, each of the leg holders has a depth that is at least 8, 10 or 12% of the maximum circumference (15) of the leg holder.

Preferably, each of the leg holders has a depth that is at most 30, 25 or 20% or less of the maximum circumference (15) of the leg holder.

An advantage of the leg holder 4 is that it is continuous—that is, an endless loop or tube that is made by stitching or otherwise joining pieces of material in a permanent manner. Of course, a seamless leg holder 4 is also good. As the leg holder 4 is continuous, there are no fastenings or straps to cause sores, rubs or pressure marks, thus eliminating the risk of such straps being ill/or incorrectly fitted by an animal handler, carer or owner. There is very little risk of the animal becoming caught up on an object by the leg holders due to their close fitting to the animal's hind limbs. This is a great advantage when the wearer is a dog, as it is all too easy for the animal to become trapped in a thicket when playing or hunting and wearing a coat with leg straps.

When the animal coat 6 is made with a stretch fabric, the animal has the possibility of its natural movement being less restricted than with other types of animal coat, and the leg holders 4 being made of a stretch fabric may absorb the animal's hind limb movements by their elasticity whilst the front legs are left free. Using one or more additional front leg holder would be possible but largely superfluous in maintaining the animal coat in place and could possibly cause extra drag on the animal's shoulders during the natural movement of the animal.

The animal coat 6 with leg holders 4 is a great advantage to the larger breed of dog to prevent inclement weather from blowing the coat away from the animal's back. This eliminates the need to use leg straps with all the disadvantages already listed above. The aesthetic appearance of the animal coat 6 as described and as seen in FIGS. 1 does not detract from a large dog's appearance—for example, for guard dogs and other working dogs where a “no-nonsense” appearance is essential.

The structure of the leg holders 4 is such that they have no need for a fastening means (for example, Velcro® fastening, buckles, buttons or any other fastening means) applied around or to the leg holders, being of a continuous soft stretch fabric joined by a seam of stitching 9. This eliminates the risk of injury or damage to the animal from hard or fixed areas being in contact with a moving area of the animal's skin. Placing the animal's hind limb into and through the leg holder is both quick and easy to do.

The animal coat 6 as described and illustrated uses the traditional animal blanket style or shape to cover the animal. As seen in FIGS. 1 and 2, although it is now securely tethered on the animal at its three location points, the coat still hangs loosely down the sides of the animal, without being closely tied around the animal's body. This well-tried and tested style or shape of animal coat has been used for many centuries and is still considered the most suitable style or shape for an animal coat. The reason for this is that it enables the animal freedom of movement and warmth without compressing the animal's fur or hair to the extent that the natural layer of insulating air in the animal's fur or hair is eliminated. This is especially so when the fabric of the animal coat chosen is of a stretch, lightweight and breathable nature. During the animal's movement or exercise, the blanket style or type of animal coat helps to prevent the animal from overheating by having the abdominal area free of covering, giving the opportunity for some loss of body heat to occur. This is particularly useful in the case of dogs, which as a species are unable to sweat.

It is possible to modify the animal coat—for example, as seen in FIG. 7, as a coat to aid drying the animal after a bath or swimming etc. This type of animal coat may be made from moisture-absorbent fabric such as terry towelling, for example, and the sides of the coat 19 are longer, reaching almost to the ground when worn. There may be a neck cover 20 as seen in FIG. 7 and/or a hood attached to the neck of the garment. The front of the coat is joined from the neck to the base of the chest, leaving the remainder of the front of the coat open. The front of the coat may be so joined by stitching or by a fastening that may be opened. Thus the animal is unrestricted if it wishes to run around. The lengths of the sides of the coat 19 prevent the animal owner/handler from becoming wet when the animal shakes itself, and also prevent household furnishings from becoming wet when the animal runs around or tries to wipe itself on the furnishings.

This modified coat has a number of tapes 17 attached to the underside of the coat. The tapes are sewn onto the underside of the coat at one end and attached by an attaching means (for example, a button 26) to the outside of the coat at the other end. The number of tapes required will depend upon the size of the animal and the coat. The tapes enable the sides of the animal coat to be rolled up as shown at 18 in FIGS. 9 and 10, so that they are out of the way, to make it easier to apply the coat to the animal. For example, the coat can be applied to the animal whilst the animal is still in the bath. Typically, one may let the water out of the bath, undo the tapes 17 to allow the rolled up sides 18 to fall down, and then lift the animal out of the bath, using the coat to protect the handler from getting too wet. The moisture-absorbent coat then helps speedy drying of the animal, and thereby reduces the risk of chilling.

Although a coat for a domestic pet dog has been described above, it is to be appreciated that coats in accordance with embodiments of the invention may be used for other animals—for example, pigs, domestic cats, larger species of exotic cats and exotic mammals kept in captivity, or for use on animals either for recreational or veterinary use.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An animal coat comprising:
two side portions arranged to hang down from the animal's back alongside respective sides of the animal's body;
a neck opening defined by said side portions, and arranged to engage around the animal's neck; and
two leg holders, each secured to an inner face of the coat at the rear part of a respective one of the side portions, and arranged to receive a respective hind leg of the animal.

2. An animal coat according to claim 1, wherein the leg holders are above the lower level of said side portions.

3. An animal coat according to claim 1, wherein each of the leg holders is continuous.

4. An animal coat according to claim 1, wherein each of the leg holders is of stretch material.

5. An animal coat according to claim 1, wherein each of the leg holders has a depth that is 10% or more of the maximum circumference of the leg holder.

6. An animal coat according to claim 1, wherein each of the leg holders has a depth that is at least 8, 10 or 12% of the maximum circumference of the leg holder.

7. An animal coat according to claim 1, wherein each of the leg holders has a depth that is 30% or less of the maximum circumference of the leg holder.

8. An animal coat according to claim 7, wherein the depth of each of the leg holders is at most 30, 25 or 20% of the maximum circumference of the leg holder.

9. An animal coat according to claim 8, wherein the depth of each of the leg holders is in the range 12 to 18% of the maximum circumference of the leg holder.

10. An animal coat according to claim 10, wherein the depth of each of the leg holders is 15% of the maximum circumference of the leg holder.

11. An animal coat according to claim 1, further comprising closure means for joining said two side portions such that the coat may be opened and closed to facilitate fitting of the coat.

12. An animal coat comprising:
two side portions arranged to hang down from the animal's back alongside respective sides of the animal's body; and
means for retaining at least one of said side portions in a raised position and releasing that side portion to a lowered position.

13. An animal coat according to claim 12, wherein said retaining means comprises a plurality of tapes secured to the coat and means for securing said tapes in a position in which said at least one side portion is in a raised position.

14. An animal coat according to claim 12, wherein said retaining means is arranged to retain both of said side portions in raised positions and to release said side portions to lowered positions.

15. (canceled)

16. A method of fitting an animal coat according to claim 1, the method comprising the steps of measuring dimensions of an animal, transferring those dimensions to a pattern, making an animal coat from that pattern, and fitting the coat to an animal.

17-18. (canceled)

19. An animal coat according to claim 1, further comprising means for retaining at least one of said side portions in a raised position and releasing that side portion to a lowered position.

20. An animal coat according to claim 19, wherein said retaining means comprises a plurality of tapes secured to the coat and means for securing said tapes in a position in which said at least one side portion is in a raised position.

21. An animal coat according to claim 19, wherein said retaining means is arranged to retain both of said side portions in raised positions and to release said side portions to lowered positions.
